(19) United States
(12) Patent Application Publication
(10) Pub. No.: US 2007/0181559 A1
(43) Pub. Date: Aug. 9, 2007

(54) Cooking pot for herbs

(76) Inventor: Peter Chi Lin, City of Industry, CA (US)

Correspondence Address: Raymond Y. Chan, 108 N. Ynez Ave., #128, Monterey Park, CA, 91754, US

(21) Appl. No.: 11/349,809

(22) Filed: Feb. 7, 2006

(51) Int. Cl. F27D 11/00

(52) U.S. Cl. 219/441

(57) ABSTRACT

A cooking pot includes a cooking container, an electric heat generator, and a control sensor. The cooking container has a cooking cavity and defines a bottom wall thereof. The electric heat generator includes a heat generating module, which is adapted for electrically connecting with a power source, supported within the cooking cavity of the cooking container at the bottom wall thereof, wherein the heat generating module has an upper heating surface for transmitting heat within the cooking cavity. The control sensor is mounted within the cooking cavity of the cooking container to operatively control the heat generating module in an on-and-off manner, wherein the control sensor has a sensor point positioned above the heating surface of the heat generating module such that a distance between the bottom wall and the sensor point is larger than a distance between the bottom wall and the heating surface of the heat generating module.

### BACKGROUND OF THE PRESENT INVENTION

1. Field of Invention

The present invention relates to a pot, and more particularly to a cooking pot for herbs which is arranged to stop working when water or herb solution contained in the cooking pot drops to a predetermined level.

2. Description of Related Arts

A conventional pot, such as a conventional cooking pot for herbs, usually comprises a main body having a cooking cavity for water and a predetermined amount of herbs to be disposed in the cooking cavity, an electric heat generator provided at the bottom of the cooking cavity for generating predetermined amount of heat to be transferred within the cooking cavity so as to heat up the water contained therein. When the water is heated up, the herbs will be boiled to release medical substances which are then mixed with the water. As a matter of conventional practice, a predetermined amount of water (usually in the range of 800c.c. to 1000c.c. of water) is first poured into the cooking pot, wherein the water is then boiled with the herbs to evaporate for forming a residual of about 250c.c. of water.

The electric heat generator is electrically extended to connect with an external power source for converting electrical energy into heat energy which is used to heat up the water in the cooking cavity. The cooking pot usually comprises a safety device comprising a control switch and a water sensor provided at an outer surface of said electric heat generator, wherein when the water is fully boiled and evaporate, the water sensor will detect that there is no more water in the main body and the control switch is then actuated to turn off the electric heat generator so as to ensure that the cooking pot is not overheated.

There are two major disadvantages concerning the above-mentioned cooking pot. First, since the water sensor is usually located at the outer surface of the electric heat generator, when it detects that there is no more water in the cooking cavity, the herbs may have been overheated and scorched, and the residuals may easily stick on the heat generating surface of the electric heat generator so as to render the heat transfer performance of the cooking pot unsatisfactory. In other words, it is too late for the water sensor to detect overcooking in the cooking pot. Moreover, when the residuals attach on the heat generating surface, it is difficult to clean the heat generating surface, despite its being manufactured by such non-stick materials as Telfon.

In relation to Telfon, it has been said to release poisonous substances when it is heated up to 240° C.—a temperature limit being easily reached by ordinary herbs cooking process. As a result, prolonged use of the conventional cooking pot may substantially affect the health of those who consumes the herbs and the water cooked by it.

Moreover, even though the poisonous substance is of insignificant intensity, Teflon is notorious of its ease of peeling so that as time goes by, the surface made with Teflon will gradually lose its non-stick characteristic. The residuals which have detached from the Teflon-made outer surface of the electric heat generator are well-known to be carcinogenic and yet they are easily mixed with the water in the cooking pot and consumed by the users.

### SUMMARY OF THE PRESENT INVENTION

A main object of the present invention is to provide a cooking pot which is arranged to stop working when water contained in the cooking pot drops to a predetermined level.

Another object of the present invention is to provide a cooking pot comprising a control sensor having a sensor point positioned above a heating surface of a heat generating module so that the control sensor is capable of detecting overheat just-in-time without burning anything within the cooking pot.

Another object of the present invention is to provide a cooking pot in which the heating surface is made of stainless steel so as to avoid peeling off of Teflon material as in the case of conventional cooking pots.

Another object of the present invention is to provide a cooking pot which does not involve complicated electronic and mechanical components so as to minimize the manufacturing cost of the present invention.

Accordingly, in order to accomplish the above objects, the present invention provides a cooking pot for cooking water and herbs to form a herb solution, comprising:

a cooking container having a cooking cavity and defining a bottom wall thereof; and

an electric heat generator, which comprises:

a heat generating module, which is adapted for electrically connecting with a power source, supported within the cooking cavity of the cooking container at the bottom wall thereof, wherein the heat generating module has an upper heating surface for transmitting heat within the cooking cavity; and

a control sensor mounted within the cooking cavity of the cooking container to operatively control the heat generating module in an predetermined heating manner, wherein the control sensor has a sensor point positioned above the heating surface of the heat generating module such that a distance between the bottom wall and the sensor point is larger than a distance between the bottom wall and the heating surface of the heat generating module,

whereby, when the herb solution is heated by the heat generating module to evaporate from the cooking container, a solution level of the herb solution is stopped from falling below the sensor point so as to prevent the herb solution from being scorched.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a cooking pot according to a preferred embodiment of the present invention.

FIG. 2 is an exploded perspective view of the cooking pot according to the above preferred embodiment of the present invention.

FIG. 3 is a sectional side view of the cooking pot according to the above preferred embodiment of the present invention.

### DETAILED DESCRIPTION OF THE PREFERRED EMBODIMENT

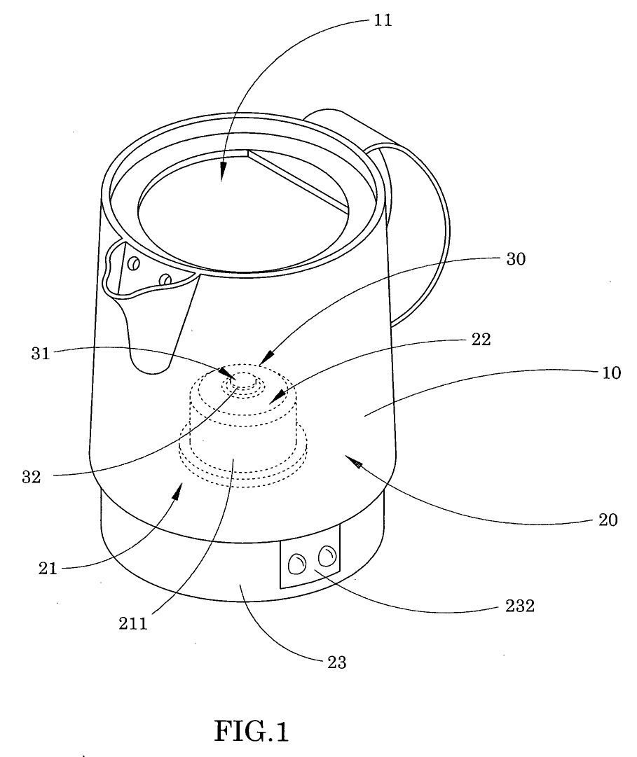

Referring to FIG. 1 to FIG. 3 of the drawings, a cooking pot, such as a cooking pot for water and herbs, according to a preferred embodiment of the present invention is illustrated, in which the cooking pot comprises a cooking container 10 having a cooking cavity 11 and defining a bottom wall 12 thereof, an electric heat generator 20, and a control sensor 30. The cooking pot is for cooking herbs and water to form a herb solution for, say, medical or supplementary use.

The electric heat generator 20 comprises a heat generating module 21, which is adapted for electrically connecting with a power source, supported within the cooking cavity 11 of the cooking container 10 at the bottom wall 12 thereof, wherein the heat generating module 21 has an upper heating surface 22 for transmitting heat within the cooking cavity 11.

The control sensor 30 is mounted within the cooking cavity 11 of the cooking container 10 to operatively control the heat generating module 21 in a predetermined heating manner (such as an on-and-off manner), wherein the control sensor 30 has a sensor point 31 positioned above the heating surface 22 of the heat generating module 21 such that a distance between the bottom wall 12 and the sensor point 31 is larger than a distance between the bottom wall 12 and the heating surface 22 of the heat generating module 21.

According to the preferred embodiment of the present invention, the cooking container 10 has a sidewall upwardly and peripherally extended from the bottom wall 12 to define a circular cross section of the cooking container 10, wherein the cooking cavity 11 is defined between the bottom wall 12 and the sidewall for heating the water and the herbs.

The electric heat generator 20 comprises a heat generator base 23 provided underneath the cooking container 10 for supporting the cooking container 10 to securely stand on top of the heat generator base 23, wherein the bottom wall 12 of the cooking container 10 has a through connecting slot 121 formed thereon in such a manner that the heat generating module 21 is adapted to electrically communicate with the heat generator base 23 via the connecting slot 121 for electrically connecting with the external power source. Accordingly, the heat generator base 23 comprises a power socket 231 provided thereon to electrically connect with the heat generating module 21, so that the power socket 231 is adapted for electrically connecting with the external power source in order to acquire electrical energy for operating the heat generating module 21. Moreover, the heat generator base 23 further comprises a heat control indicator 232 provided thereon for indicating a status a heating status of the cooking pot. For example, the heat control indictor 232 is preferably embodied as a plurality of LEDs which are utilized to indicate whether or not the water and the herbs in the cooking pot have been properly cooked.

On the other hand, the heat generating module 21 comprises a heat transfer housing 211 mounted on the bottom wall 12 of the cooking container 10 at a position above the connecting slot 121, and a heat generating unit 212 received in the heat transfer housing 211 to thermally communicate therewith, in such a manner that when the heat generating module 21 is electrically connected with the external power source, the heat generating unit 212 is arranged to heat up the upper heating surface 22 of the heat transfer housing 211 for heating up the water and herbs (the herb solution) disposed within the cooking cavity 11.

In other words, the heat generating module 21 comprises the heat generating unit 212 for electrically connecting with the power source and a heat transfer housing 211, defining the upper heating surface 22 thereon, mounted on the bottom wall 12 of the cooking container 10 to thermally communicate with the heat generating unit 212, such that the heat generating unit 212 generates heat in the heat transfer housing 211.

The cooking pot further comprises a control circuit 40 communicatively connecting the control sensor 30 with the heat generating module 21, wherein the control circuit 40 has two electric terminals 41 electrically and spacedly connecting to the heat generating module 21 at the upper heating surface 22 thereof, and a sensor terminal 42 which is electrically connecting to the control sensor 30 and is positioned above the two electric terminals 41 to form a triangle-terminal configuration.

It is important to point out that the upper heating surface 22 of the heat transfer housing 211 is made of stainless steel so as to avoid the above-mentioned disadvantages associated with the use of Teflon. In other words, the present invention endeavors to prevent the users from contacting harmful substances when they consume herbs cooked by the cooking pot.

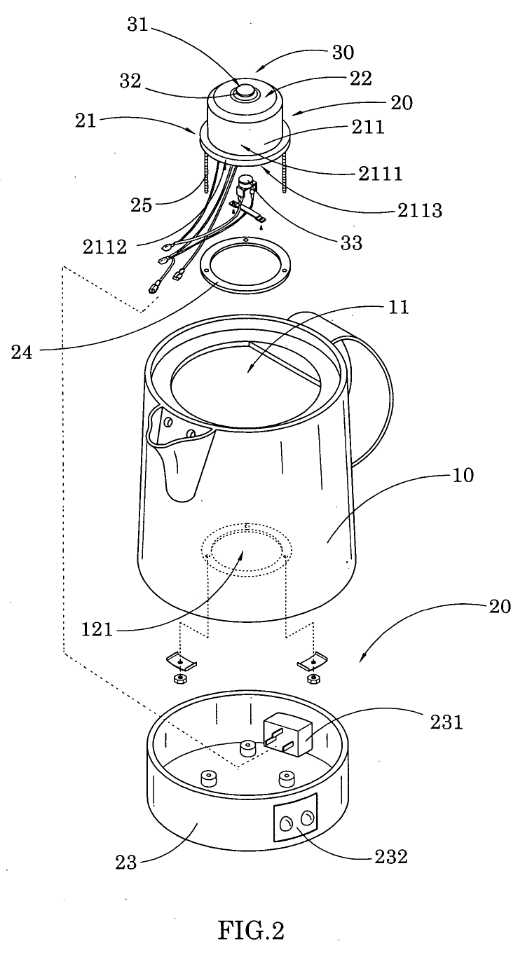

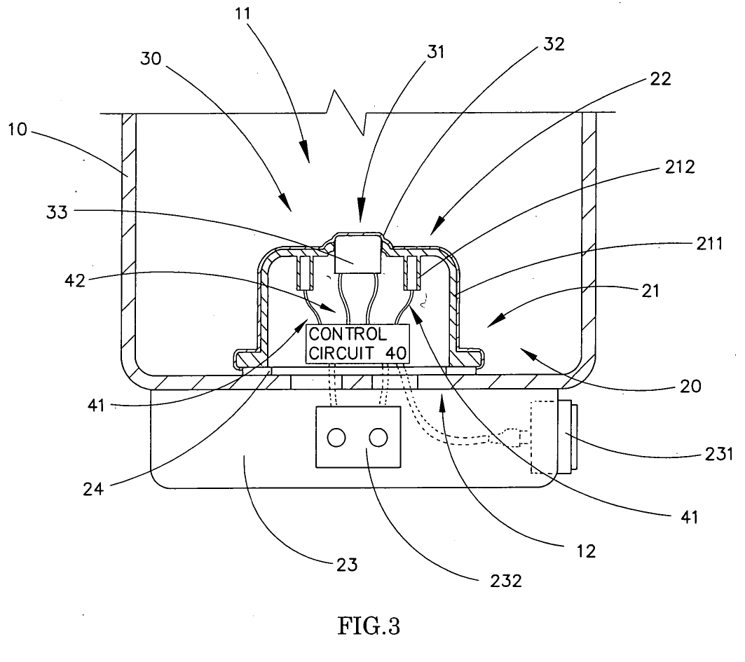

Referring to FIG. 2 to FIG. 3 of the drawings, the electric heat generator 20 further comprises a sealing ring 24 sealedly sandwiched between the heat transfer housing 211 and the bottom wall 12 so as to prevent the herb solution from leaking into the heat transfer housing 211 from the cooking cavity 11. The sealing ring 24 is preferably made of water-tight and flexible materials such as rubber for effectively sealing any gap formed between a bottom side of the heat transfer housing 211 and the bottom wall 12 of the cooking container 10.

More specifically, the heat transfer housing 211 has an upper heat transfer portion 2111 which is cylindrically shaped to form a circular cross section, and an enlarged seat portion 2112 integrally, outwardly and peripherally extended from a bottom side edge of the upper heart transfer portion 2111 to define an enlarged sealing surface 2113 of the heat transfer housing 211 as a bottom side surface thereof, wherein the sealing ring 24 is fittedly sandwiched between the bottom wall 12 and the enlarged sealing surface 2113 of the heat transfer housing 211. As a result, an outer diameter of the sealing ring 24 is substantially the same as an outer diameter of the enlarged seat portion 2112 of the heat transfer housing 211 so as to tightly blocking the herb solution from leaking into the heat transfer housing 211.

The control sensor 30 further comprises a sensor housing 32 integrally and upwardly protruded from the upper heating surface 22 wherein the sensor point 31 is provided at the highest position of the sensor housing 32 at a position above the upper heating surface 22 for sensing the solution level in the cooking cavity 11.

Moreover, the control sensor 30 further comprises a solution level sensor 33 supported by the heat transfer housing 211 to receive in the sensor housing 32, and two terminals extended from the solution level sensor 33 to electrically connect with the electric heat generator 20 within the heat transfer housing 211 for selectively controlling an operation of the electric heat generator 20 corresponding with a solution level in the cooking cavity 11.

More specifically, the solution level sensor 33 is mounted on the upper heating surface 22 of the heat generating module 21 in such a manner that when the solution level sensor 33 detects a solution level within the cooking container 10 below the sensor point 31, the heat generating module 21 is deactivated to stop generating heat so as to ensure the solution level is above the upper heating surface 22 of the heat generating module 21.

In order to mount the heat transfer housing 211 onto the bottom wall 12 of the cooking container 10, the electric heat generator 20 further comprises a plurality of connecting elements 25 penetrating the sealing ring 24, enlarged seat portion 2112 of the heat transfer housing 21 and the bottom wall 12 to mount with the heat generator base 23 so as to securely connect the heat transfer housing 21 and the cooking container 10 with the heat generator base 23.

The operation of the present invention is as follows: a predetermined proportion of water and a predetermined amount of herbs are first put into the cooking container 10. After that, the electric heat generator 20 is electrically connected with the external power source for heating the water and the herbs in the cooking container 10. When the water is heated up, it will gradually evaporate and the water and the herbs are mixed to form the herb solution, the solution level of which will go down along the cooking cavity 11. When the water is evaporated such that the sensor point 31 is above the solution level, the solution level sensor 33 is arranged to stop the electric heat generator 20 so as to stop heating the water (and the herbs). As a result, the solution level will stay at a position above the sensor point 31 and the herb solution (and the residuals) contained in the cooking container 10 is prevented from being scorched.

It is worth mentioning that the cooking pot of the present invention may also be embodied as a slow cooker which is adapted for cooking food for a prolonged period of time. In this scenario, the control sensor 30 is capable of stopping the slow cooker just-in-time when the there is inadequate water in the cooking container 10.

One skilled in the art will understand that the embodiment of the present invention as shown in the drawings and described above is exemplary only and not intended to be limiting.

It will thus be seen that the objects of the present invention have been fully and effectively accomplished. Its embodiment have been shown and described for the purposes of illustrating the functional and structural principles of the present invention and is subject to change without departure from such principles. Therefore, this invention includes all modifications encompassed within the spirit and scope of the following claims.

What is claimed is:

1. A cooking pot for cooking water and herbs to form a herb solution, comprising:
a cooking container having a cooking cavity and defining a bottom wall thereof; and
an electric heat generator, which comprises:
a heat generating module, which is adapted for electrically connecting with a power source, supported within said cooking cavity of said cooking container at said bottom wall thereof, wherein said heat generating module has an upper heating surface for transmitting heat within said cooking cavity; and
a control sensor mounted within said cooking cavity of said cooking container to operatively control said heat generating module in an predetermined heating manner, wherein said control sensor has a sensor point positioned above said heating surface of said heat generating module such that a distance between said bottom wall and said sensor point is larger than a distance between said bottom wall and said heating surface of said heat generating module,
whereby, when said herb solution is heated by said heat generating module to evaporate from said cooking container, a solution level of said herb solution is stopped from falling below said sensor point so as to prevent said herb solution from being scorched.

2. The cooking pot, as recited in claim 1, wherein said control sensor comprises a solution level sensor mounted on said upper heating surface of said heat generating module in such a manner that when said solution level sensor detects a solution level within said cooking container below said sensor point, said heat generating module is deactivated to stop generating heat so as to ensure said solution level above said upper heating surface of said heat generating module.

3. The cooking pot, as recited in claim 1, wherein said heat generating module comprises a heat generating unit for electrically connecting with said power source and a heat transfer housing, defining said upper heating surface thereon, mounted on said bottom wall of said cooking container to thermally communicate with said heat generating unit, such that said heat generating unit generates heat said heat transfer housing.

4. The cooking pot, as recited in claim 2, wherein said heat generating module comprises a heat generating unit for electrically connecting with said power source and a heat transfer housing, defining said upper heating surface thereon, mounted on said bottom wall of said cooking container to thermally communicate with said heat generating unit, such that said heat generating unit generates heat said heat transfer housing.

5. The cooking pot, as recited in claim 3, further comprising a sensor housing integrally and upwardly protruded from said upper heating surface of said heat transfer housing to receive said control sensor such that said sensor point is formed at a highest position of said sensor housing above said upper heating surface of said heat transfer housing.

6. The cooking pot, as recited in claim 4, further comprising a sensor housing integrally and upwardly protruded from said upper heating surface of said heat transfer housing to receive said control sensor such that said sensor point is formed at a highest position of said sensor housing above said upper heating surface of said heat transfer housing.

7. The cooking pot, as recited in claim 4, wherein said heat transfer housing is made of stainless steel.

8. The cooking pot, as recited in claim 6, wherein said heat transfer housing is made of stainless steel.

9. The cooking pot, as recited in claim 4, wherein said electric heat generator further comprises a sealing ring, which is made water-tight and flexible materials, sealedly sandwiched between said heat transfer housing and said bottom wall for preventing said herb solution from leaking into said heat transfer housing.

10. The cooking pot, as recited in claim 6, wherein said electric heat generator further comprises a sealing ring, which is made water-tight and flexible materials, sealedly sandwiched between said heat transfer housing and said bottom wall for preventing herb solution from leaking into said heat transfer housing.

11. The cooking pot, as recited in claim 8, wherein said electric heat generator further comprises a sealing ring, which is made water-tight and flexible materials, sealedly sandwiched between said heat transfer housing and said bottom wall for preventing said herb solution from leaking into said heat transfer housing.

12. The cooking pot, as recited in claim 9, wherein said electric heat generator comprises a heat generator base mounted underneath said cooking container and a power socket supported at said heat generator base, wherein said bottom wall of said cooking container has a through connecting slot formed thereon in such a manner that said heat generating unit is electrically connected with said power socket through said connecting slot for electrically connecting with said power source.

13. The cooking pot, as recited in claim 10, wherein said electric heat generator comprises a heat generator base mounted underneath said cooking container and a power socket supported at said heat generator base, wherein said bottom wall of said cooking container has a through connecting slot formed thereon in such a manner that said heat generating unit is electrically connected with said power socket through said connecting slot for electrically connecting with said power source.

14. The cooking pot, as recited in claim 11, wherein said electric heat generator comprises a heat generator base mounted underneath said cooking container and a power socket supported at said heat generator base, wherein said bottom wall of said cooking container has a through connecting slot formed thereon in such a manner that said heat generating unit is electrically connected with said power socket through said connecting slot for electrically connecting with said power source.

15. The cooking pot, as recited in claim 12, wherein said heat transfer housing has an upper heat transfer portion which is cylindrically shaped to form a circular cross section, and an enlarged seat portion integrally, outwardly and peripherally extended from a bottom side edge of said upper heart transfer portion to define an enlarged sealing surface of said heat transfer housing as a bottom side surface thereof, wherein said sealing ring is fittedly sandwiched between said bottom wall and said enlarged sealing surface for tightly blocking said herb solution from leaking into said heat transfer housing.

16. The cooking pot, as recited in claim 13, wherein said heat transfer housing has an upper heat transfer portion which is cylindrically shaped to form a circular cross section, and an enlarged seat portion integrally, outwardly and peripherally extended from a bottom side edge of said upper heart transfer portion to define an enlarged sealing surface of said heat transfer housing as a bottom side surface thereof, wherein said sealing ring is fittedly sandwiched between said bottom wall and said enlarged sealing surface for tightly blocking said herb solution from leaking into said heat transfer housing.

17. The cooking pot, as recited in claim 14, wherein said heat transfer housing has an upper heat transfer portion which is cylindrically shaped to form a circular cross section, and an enlarged seat portion integrally, outwardly and peripherally extended from a bottom side edge of said upper heart transfer portion to define an enlarged sealing surface of said heat transfer housing as a bottom side surface thereof, wherein said sealing ring is fittedly sandwiched between said bottom wall and said enlarged sealing surface for tightly blocking said herb solution from leaking into said heat transfer housing.

18. The cooking pot, as recited in claim 1, further comprising a control circuit communicatively connecting said control sensor with said heat generating module, wherein said control circuit has two electric terminals electrically and spacedly connecting to said heat generating module at said upper heating surface thereof, and a sensor terminal which is electrically connecting to said control sensor and is positioned above said two electric terminals to form a triangle-terminal configuration.

19. The cooking pot, as recited in claim 8, further comprising a control circuit communicatively connecting said control sensor with said heat generating module, wherein said control circuit has two electric terminals electrically and spacedly connecting to said heat generating module at said upper heating surface thereof, and a sensor terminal which is electrically connecting to said control sensor and is positioned above said two electric terminals to form a triangle-terminal configuration.

20. The cooking pot, as recited in claim 17, further comprising a control circuit communicatively connecting said control sensor with said heat generating module, wherein said control circuit has two electric terminals electrically and spacedly connecting to said heat generating module at said upper heating surface thereof, and a sensor terminal which is electrically connecting to said control sensor and is positioned above said two electric terminals to form a triangle-terminal configuration.
